(19) United States
(12) Patent Application Publication
(10) Pub. No.: US 2015/0212617 A1
(43) Pub. Date: Jul. 30, 2015

(54) TOUCH SENSOR

(71) Applicant: SAMSUNG ELECTRO-MECHANICS CO., LTD., Gyeonggi-Do (KR)

(72) Inventors: Young Seuck YOO, Gyeonggi-Do (KR); Kang Heon HUR, Gyeonggi-Do (KR); Sung HAN, Gyeonggi-Do (KR); Dek Gin YANG, Gyeonggi-Do (KR); Jae Ho SHIN, Gyeonggi-Do (KR); Youn Soo KIM, Gyeonggi-Do (KR); Seung Joo SHIN, Gyeonggi-Do (KR); Hyun Dong LEE, Gyeonggi-Do (KR)

(73) Assignee: SAMSUNG ELECTRO-MECHANICS CO., LTD., Gyeonggi-Do (KR)

(21) Appl. No.: 14/272,762

(22) Filed: May 8, 2014

(30) Foreign Application Priority Data
Jan. 24, 2014 (KR) 10-2014-0009161

(51) Int. Cl. G06F 3/044

(52) U.S. Cl. CPC G06F 3/044; G06F 2203/04103; G06F 2203/04112

(57) ABSTRACT

Embodiments of the invention provide a touch sensor, including a window substrate, a first electrode pattern adhered onto one surface of the window substrate and including a first metal fine line formed by laminating at least two electrode layers on one surface of a base substrate, and a second electrode pattern including a second metal fine line formed by laminating at least two electrode layers on the other surface of the base substrate. According to an embodiment, the first and the second metal fine lines have a number of laminated electrode layers different from each other.

### CROSS REFERENCE TO RELATED APPLICATION

This application claims the benefit of and priority under 35 U.S.C. §119 to Korean Patent Application No. KR 10-2014-0009161, entitled “Touch Sensor,” filed on Jan. 24, 2014, which is hereby incorporated by reference in its entirety into this application.

### BACKGROUND

1. Field of the Invention

The present invention relates to a touch sensor.

2. Description of the Related Art

In accordance with the growth of computers using a digital technology, devices assisting computers have also been developed, and personal computers, portable transmitters and other personal information processors execute processing of text and graphic using a variety of input devices such as a keyboard and a mouse.

In accordance with the rapid advancement of an information-oriented society, the use of computers has gradually been widened. However, it is difficult to efficiently operate products using only the keyboard and the mouse currently serving as the input device. Therefore, the necessity for a device that is simple, has minimum malfunction, and is capable of easily inputting information has increased.

Additionally, current techniques for input devices have progressed toward techniques related to high reliability, durability, innovation, designing and processing beyond the level of satisfying general functions. To this end, a touch sensor has been developed as an input device capable of inputting information such as text or a graphic.

This touch sensor is mounted on a display surface of a display, such as an electronic organizer, a flat panel display device including a liquid crystal display (LCD) device, a plasma display panel (PDP), an electroluminescence (El) element, or a cathode ray tube (CRT) to thereby be used to allow a user to select desired information while viewing the display.

Additionally, the touch sensor is classified into a resistive type touch sensor, a capacitive type touch sensor, an electromagnetic type touch sensor, a surface acoustic wave (SAW) type touch sensor, and an infrared type touch sensor. These various types of touch sensors are adapted for electronic products in consideration of a signal amplification problem, a resolution difference, a level of difficulty of designing and processing technologies, optical characteristics, electrical characteristics, mechanical characteristics, environment resistance, input characteristics, durability, and economic efficiency. Currently, the resistive type touch sensor and the capacitive type touch sensor have been prominently used in a wide range of fields.

Meanwhile, in the touch sensor, research into a technology of forming an electrode pattern using a metal has been actively conducted, as described, for example, in the Japanese Patent Application No. JP2011-175967 A. As described above, when the electrode pattern is formed using the metal, electric conductivity is excellent and demand and supply is smooth. However, in the case in which the electrode pattern is formed using the metal, there was a problem that the electrode pattern may be visible to a user. Particularly, there were various problems such as visibility of the electrode patterns due to opacity of metal electrodes used for conductivity, a decrease in reliability due to corrosion resistance of exposed electrode patterns, warpage of a transparent substrate or the electrode pattern caused by thermal stress during the process of forming the electrode pattern on both surfaces of the transparent substrate.

### SUMMARY

Accordingly, embodiments of the invention have been made in an effort to provide a touch sensor capable of improving corrosion resistance of an exposed part of an electrode pattern and adhesion reliability between the electrode pattern and a transparent substrate and solving a visibility problem of the electrode pattern due to a conductive metal by forming the electrode pattern of the touch sensor in a laminated structure using at least two heterogeneous materials.

Furthermore, embodiments of the invention have been made in an effort to provide a touch sensor capable of preventing thermal damage of the transparent substrate and the electrode pattern due to thermal stress, which is generated during a process of depositing the electrode pattern on both surfaces of the transparent substrate by differently forming the laminated structure and a laminated thickness of the electrode pattern formed on both surfaces of the transparent substrate.

According to an embodiment of the invention, there is provided a touch sensor, including a window substrate, a first electrode pattern adhered onto one surface of the window substrate and including a first metal fine line formed by laminating at least two electrode layers on one surface of a base substrate, and a second electrode pattern including a second metal fine line formed by laminating at least two electrode layers on the other surface of the base substrate. The first and the second metal fine lines have a number of laminated electrode layers different from each other.

According to an embodiment, the first metal fine line is formed by sequentially laminating a first electrode layer, a second electrode layer, and a third electrode layer, and the second metal fine line is formed by sequentially laminating a fourth electrode layer and a fifth electrode layer.

According to an embodiment, the first metal fine line has thicknesses of the first and third electrode layers in a laminated direction formed to be thinner than a thickness of the second electrode layer, and the second metal fine line has a thickness of the fourth electrode layer in the laminated direction formed to be thinner than a thickness of the fifth electrode layer.

According to an embodiment, the second metal fine line has the thickness of the fourth electrode layer in the laminated direction formed to be thicker than the thickness of the first electrode layer in the laminated direction of the first electrode pattern.

According to an embodiment, the second metal fine line has the thickness of the fifth electrode layer in the laminated direction formed to be thicker than the thickness of the second electrode layer in the laminated direction of the first metal fine line.

According to an embodiment, the thickness of the first electrode layer is 30 nm, and the thickness of the fourth electrode layer is formed to be 30 nm to 50 nm.

According to an embodiment, the first electrode layer, the third electrode layer, and the fourth electrode layer are made of an alloy of copper (Cu) and nickel (Ni).

According to an embodiment, the second electrode layer and the fifth electrode layer are made of copper (Cu), aluminum (Al), or a combination thereof.

According to an embodiment, the first and second electrode patterns are a mesh pattern formed of the metal fine line.

According to an embodiment, the second electrode pattern has the thickness of the fifth electrode layer in the laminated direction formed to be thicker than the thickness of the second electrode layer in the laminated direction of the first electrode pattern as much as 10% to 15%.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a cross-sectional view of a touch sensor according to an embodiment of the invention.

FIG. 2 is a plane view of an electrode pattern according to an embodiment of the invention.

FIG. 3 is a cross-sectional view of an electrode pattern taken along I-I′ of FIG. 2 according to another embodiment of the invention.

FIG. 4 is a diagram showing light transmittance for a thickness of an electrode layer configuring the electrode pattern according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

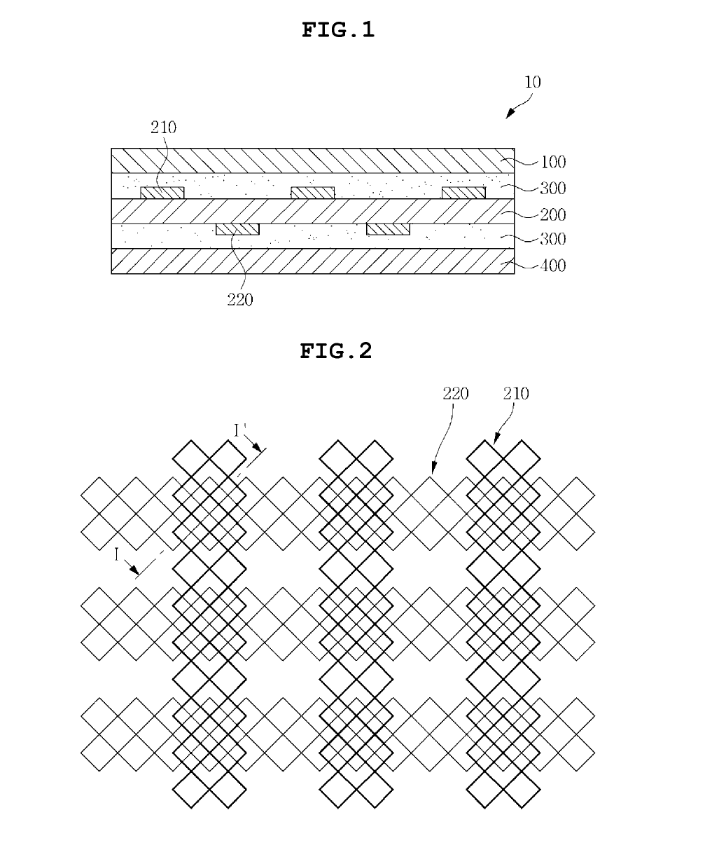

Hereinafter, a touch sensor according to an embodiment of the invention will be described in detail with reference to the accompanying drawings. FIG. 1 is a cross-sectional view of a touch sensor according to an embodiment of the invention, and FIG. 2 is a plane view of an electrode pattern according to an embodiment of the invention.

As shown in FIG. 1, a touch sensor 10, according to an embodiment of the invention, is configured to include a base substrate 200 and first and second electrode patterns 210 and 220, which are each formed on both surfaces of the base substrate 200, wherein the first and second electrode patterns 210 and 220 are formed, according to an embodiment, by laminating at least two electrode layers and a display part 400 for representing an output value for an input of a user by the touch sensor is adhered on the second electrode pattern 220 formed on the other surface of the baste substrate 200 by an adhesive 300. The display part 400, which is an image device, includes various display devices, such as a liquid crystal display (LCD) and an organic light emitting diode (OLED), but is not limited to a specific kind of device.

According to an embodiment, a window substrate 100 is disposed at the outermost portion of the touch sensor 10 to receive a touch from the user and is formed, for example, of a tempered glass to serve as a protection layer. Because the window substrate 100 has a bezel part (not shown) and electrode patterns 121 and 122 formed on a rear surface thereof, a surface treatment layer (not shown) is formed by performing high frequency treatment or a primer treatment on the rear surface of the window substrate 100 to improve adhesion between the window substrate 100 and the bezel part (not shown) or the electrode patterns 121 and 122.

As shown in FIG. 2, the transparent substrate 200 is made of any material, which has a predetermined strength or more and is transparent to allow an image of the display part 400 to be output. For example, the base substrate 200 is made of polyethylene terephthalate (PET), polycarbonate (PC), poly methyl methacrylate (PMMA), polyethylene naphthalate (PEN), polyethersulfone (PES), cyclic olefin polymer (COC), triacetylcellulose (TAC) film, polyvinyl alcohol (PVA) film, polyimide (PI) film, polystyrene (PS), biaxially stretched polystyrene (K resin containing biaxially oriented PS; BOPS), glass, or tempered glass, but is not necessarily limited thereto. In addition, because the electrode patterns 210 and 220 are formed on one surface of the base substrate 200, the surface treatment layer is formed by performing high frequency treatment or primer treatment on one surface of the base substrate 200 to improve adhesion between the base substrate 200 and the electrode patterns 210 and 220.

As shown in FIG. 2, the first electrode patterns 210, according to an embodiment of the invention, are formed on one surface of the base substrate 200 to be in parallel with each other and the second electrode patterns 220 are formed on the other surface of the base substrate 200 to intersect with a direction in which the first electrode pattern 210 is formed. According to another embodiment, although the first electrode patterns 210 and the second electrode patterns 220 are generally shown in a bar pattern, a shape and a structure of the first and second electrode patterns 210 and 220, according to this embodiment of the invention, are not particularly limited.

According to an embodiment, the first and second electrode patterns 210 and 220 are formed as a mesh pattern, which is formed of metal fine lines, and the mesh pattern is not limited to having a specific shape, but has a polygonal shape, such as a rectangular shape, a triangular shape, or a diamond shape, as non-limiting examples. The first and second electrode patterns 210 and 220 are formed in a mesh pattern using copper (Cu), aluminum (Al), gold (Au), silver (Ag), titanium (Ti), palladium (Pd), chromium (Cr), nickel (Ni) or a combination thereof.

According to an embodiment, the first and second electrode patterns 210 and 220 are formed by a dry process, a wet process, or a direct patterning process. The dry process includes a sputtering process or an evaporation process, as non-limiting examples, the wet process includes a dip coating process, a spin coating process, a roll coating process, or a spray coating process, as non-limiting examples, and the direct patterning process includes a screen printing process, a gravure printing process, or an inkjet printing process, as non-limiting examples.

In addition, a photosensitive material is applied onto the first and second electrode patterns 210 and 220 on the base substrate 200 using a photolithograph and light is irradiated using a mask formed in a desired pattern. Then, a developing process for forming a desired pattern, for example, removing a portion of the photosensitive material to which the light is irradiated using a developer, removing a portion of the photosensitive material to which the light is not irradiated using a developer is performed. Then, the photosensitive material is formed in a specific pattern, and the remaining portion is removed by an etchant by using the photosensitive material as a resist. Then, when the photosensitive material is removed, the electrode patterns 210 and 220 having a desired pattern are manufactured.

According to an embodiment, the mesh pattern, as described above, has a problem in that the first and second electrode patterns 210 and 220 are viewed by the user of the touch sensor as the first and second electrode patterns 210 and 220 are formed using the opaque metal fine lines. Therefore, the first and second electrode patterns 210 and 220 including the mesh pattern need to have decreased visibility, while being implemented as a fine pattern. In addition, since the first and second electrode patterns 210 and 220 are formed in the mesh pattern using the metal fine lines, the electrode patterns 210 and 220 connected to an electrode wiring connecting a cathode and an anode to each other or potential difference are easily corroded, such that a durability problem occurs.

Therefore, according to an embodiment of the invention, at least two electrode layers are sequentially laminated and formed by effectively combining the materials of the first and second electrode patterns 210 and 220 and a metal of a separate material for securing conductivity of the first and second electrode patterns 210 and 220 and preventing corrosion are alloyed, such that resistance to an environment and visibility of the first and second electrode patterns 210 and 220 are more effectively improved.

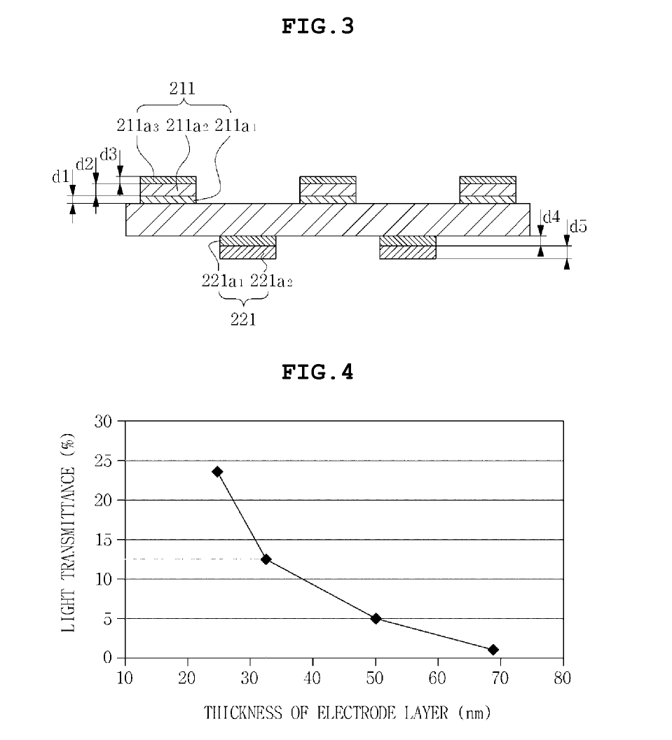

Hereinafter, a plurality of electrode layers configuring the first and second electrode patterns of the touch sensor according to an embodiment of the invention will be described in detail with reference to FIGS. 3 and 4.

FIG. 3 is a cross-sectional view of an electrode pattern taken along I-I′ of FIG. 2 according to another embodiment of the invention, and FIG. 4 is a diagram showing light transmittance for a thickness of an electrode layer configuring the electrode pattern according to this embodiment of the invention.

As shown in FIG. 3, the first electrode pattern 210 is adhered onto one surface of the window substrate 100 and includes a first metal fine line 211 having a first electrode layer 211ₐ₁, a second electrode layer 211ₐ₂, and a third electrode layer 211ₐ₃ sequentially laminated on one surface of the base substrate 200, and formed by a patterning process. According to an embodiment of the invention, with respect to thicknesses d1, d2, and d3 of the first to third electrode layers 211ₐ₁, 211ₐ₂, and 211ₐ₃ in a laminated direction, since the thickness d1 of the first electrode layer 211ₐ₁ is formed to be thinner than the thickness d2 of the second electrode layer 211ₐ₂ and the thicknesses d3 and d1 of the third electrode layer 211ₐ₃ and the first electrode layer 211ₐ₁ are formed to be equal to each other, the thicknesses d1 and d3 of the first electrode layer 211ₐ₁ and the third electrode layer 211ₐ₃ are formed to be 30 nm, and the thickness d2 of the second electrode layer 211ₐ₂ is formed to be 160 nm, but are not limited thereto.

In addition, the second electrode pattern 220 includes a second metal fine line 221 having a fourth electrode layer 221ₐ₁ and a fifth electrode layer 221ₐ₂ sequentially laminated on the other surface of the base substrate 200 and formed by the patterning process, a thickness d4 of the fourth electrode layer 221ₐ₁ in the laminated direction is formed to be thicker than the thickness d1 of the first electrode layer 211ₐ₁ of the first meal fine wire 211 in the laminated direction, and the thickness d4 of the fourth electrode layer 221ₐ₁ is formed to be 30 nm to 50 nm.

Thus according to an embodiment, the fourth electrode layer 221ₐ₁ contacting the other surface of the base substrate 200 improves an etching rate in an etching process, which is involved in forming the second electrode pattern 220 to more easily implement the fine electrode pattern 220 and secure adhesion with base substrate 200. Therefore, visibility of fifth electrode layer 221ₐ₂ laminated on the fourth electrode layer 221ₐ₁ and made of copper needs to be decreased.

As shown in FIG. 3, the thickness d4 of the fourth electrode layer 221ₐ₁ is formed within 10 nm to 15 nm to secure adhesion with the base substrate 200, but in order to decrease visibility of the fifth electrode layer 221ₐ₂ formed on the fourth electrode layer 221ₐ₁, the thickness d4 of the fourth electrode layer 221ₐ₁ is formed to be 30 nm or more, and is formed within 30 nm to 50 nm so that light transmittance (%) is 10% or less.

In addition, the thickness d5 of the fifth electrode layer 221ₐ₂ in the laminated direction is formed to be thicker than the thickness d2 of the second electrode layer 211ₐ₂ of the first metal fine line 211 and the thickness d5 of the fifth electrode layer 221ₐ₂ is formed to be thicker than the thickness d2 of the second electrode layer 211ₐ₂ of the first metal fine line 211 as much as 10% to 15%.

Thus, in order to prevent thermal damage (e.g., thermal wrinkles, etc.) of the base substrate 200 or the first electrode pattern 210, which is generated during a process of forming the second electrode pattern 220 on the other surface of the base substrate 200 by a sputtering process after depositing the first electrode pattern 210 on one surface of the base substrate 200 by the sputtering process, the thickness d5 of the fifth electrode layer 221ₐ₂ is formed to be thicker than the thickness d2 of the second electrode layer 211ₐ₂ of the first electrode pattern 210 and is formed to be thicker than the thickness d2 of the second electrode layer 211ₐ₂ as much as 10% to 15%.

Here, the first electrode layer 211ₐ₁ of the first metal fine line 211 formed on one surface of the base substrate 200 and the fourth electrode layer 221ₐ₁ of the second metal fine line 221 formed on the other surface thereof is made of an alloy of copper and nickel, and improves an etching rate in an etching process, which is involved in forming the first and second electrode patterns 210 and 220 to more easily implement the fine electrode patterns 210 and 220.

Further, according to an embodiment, the third electrode layer 211ₐ₃ of the first metal fine line 211 is made of corrosion resistance material for preventing a decrease in electrical reliability due to corrosion of the first and second electrode patterns 210 and 220 and is made of the material for improving visibility by the user at the outermost portion, and the second electrode layer 211ₐ₂ of the first metal fine line 211 and the fourth electrode layer 221ₐ₁ of the second metal fine line is made of copper, aluminum, or a combination thereof, and the material of the second electrode layer 211ₐ₂ and the fourth electrode layer 221ₐ₁ are selected and adopted in consideration of electrical conductivity.

As described above, the laminated structure and the laminated thickness of the electrode pattern formed on both surfaces of the transparent substrate are formed differently, such that thermal damage of the transparent substrate and the electrode pattern due to thermal stress, which is generated during the process of depositing the electrode pattern on both surfaces of the transparent substrate is prevented, thereby making it possible to more easily secure operation performance and driving reliability of the touch sensor.

According to an embodiment of the invention, the electrode layer of the electrode pattern contacting the transparent substrate is formed of the thin film layer by the multilayer structure of the electrode pattern of the touch sensor, thereby making it possible to further improve adhesion between the electrode layer and the transparent substrate.

In addition, the upper electrode layer of the electrode pattern, which is exposed to the outermost portion viewed by the user is formed of the alloy layer containing nickel (Ni), thereby making it possible to decrease visibility of the electrode pattern by the user

In addition, the laminated structure and a laminated thickness of the electrode layer configuring the electrode patterns formed on both surfaces of the transparent substrate are formed differently, such that thermal damage of the transparent substrate and the electrode pattern due to thermal stress which may be generated during the process of depositing the electrode pattern on both surfaces of the transparent substrate is prevented, thereby making it possible to more easily secure operation performance and driving reliability of the touch sensor.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A touch sensor, comprising:
a window substrate;
a first electrode pattern adhered onto one surface of the window substrate, the first electrode pattern comprising a first metal fine line formed by laminating at least two electrode layers on one surface of a base substrate; and
a second electrode pattern comprising a second metal fine line formed by laminating at least two electrode layers on the other surface of the base substrate,
wherein the first and the second metal fine lines comprise a number of laminated electrode layers different from each other.

2. The touch sensor as set forth in claim 1, wherein the first metal fine line is formed by sequentially laminating a first electrode layer, a second electrode layer, and a third electrode layer, and
wherein the second metal fine line is formed by sequentially laminating a fourth electrode layer and a fifth electrode layer.

3. The touch sensor as set forth in claim 2, wherein the first metal fine line has thicknesses of the first and third electrode layers in a laminated direction formed to be thinner than a thickness of the second electrode layer, and
wherein the second metal fine line has a thickness of the fourth electrode layer in the laminated direction formed to be thinner than a thickness of the fifth electrode layer.

4. The touch sensor as set forth in claim 3, wherein the second metal fine line has the thickness of the fourth electrode layer in the laminated direction formed to be thicker than the thickness of the first electrode layer in the laminated direction of the first electrode pattern.

5. The touch sensor as set forth in claim 4, wherein the second metal fine line has the thickness of the fifth electrode layer in the laminated direction formed to be thicker than the thickness of the second electrode layer in the laminated direction of the first metal fine line.

6. The touch sensor as set forth in claim 5, wherein the thickness of the first electrode layer is 30 nm, and
wherein the thickness of the fourth electrode layer is formed to be 30 nm to 50 nm.

7. The touch sensor as set forth in claim 2, wherein the first electrode layer, the third electrode layer, and the fourth electrode layer are made of an alloy of copper (Cu) and nickel (Ni).

8. The touch sensor as set forth in claim 2, wherein the second electrode layer and the fifth electrode layer are made of copper (Cu), aluminum (Al), or a combination thereof.

9. The touch sensor as set forth in claim 1, wherein the first and second electrode patterns are a mesh pattern formed of the metal fine line.

10. The touch sensor as set forth in claim 5, wherein the second electrode pattern has the thickness of the fifth electrode layer in the laminated direction formed to be thicker than the thickness of the second electrode layer in the laminated direction of the first electrode pattern as much as 10% to 15%.
